(19) United States
(12) Patent Application Publication
(10) Pub. No.: US 2022/0417352 A1
(43) Pub. Date: Dec. 29, 2022

(54) Cell Phone With Side Cameras

(71) Applicant: Robert D. Fish, Irvine, CA (US)

(72) Inventor: Robert D. Fish, Irvine, CA (US)

(21) Appl. No.: 17/845,081

(22) Filed: Jun. 21, 2022

Related U.S. Application Data
(60) Provisional application No. 63/214,926, filed on Jun. 25, 2021.

(51) Int. Cl. H04M 1/02

(52) U.S. Cl. CPC H04M 1/0264

(57) ABSTRACT

A smartphone is configured to capture images through a front facing aperture, and at least one side facing aperture. Such captures can be made by one or more cameras, which can optionally capture the images concurrently, and can optionally use optical fibers to convey images. The smartphone can also have a back facing camera, which can also capture images concurrently with images received through any of the front facing and side facing apertures. Captured images, whether still and/or moving (video), can being stitched together. Any one or more of the cameras and/or apertures can optionally be digitally and/or physically steerable. Also contemplated is a smartphone case having apertures that correspond to the image receiving apertures of the smartphone.

The field of the invention is a device, especially related to a smartphone.

The background description includes information that may be useful in understanding the present invention. It is not an admission that any of the information provided herein is prior art or relevant to the presently claimed invention, or that any publication specifically or implicitly referenced is prior art.

Taking images using a smartphone has been significantly improved and even an amateur individual can take a video with high quality and enjoys publishing it in social media. Accordingly, the demand from users is always growing and the manufactures are eager to expand the capability of the camera with lower cost.

WIPO application, WO 2020/215933 to Gong et al. teaches a cell phone having pop-up cameras allowing a user to concurrently obtain forward as well as backward images. However, the cameras are unable to concurrently capture front, as well as left and right side views. Nor is there any teaching, suggestion, or motivation to capture side images.

US patent, U.S. Ser. No. 10/777,094 to Rao et al. teaches eye-glasses having both a front camera and a side-facing camera. Rao et al. contemplates that his dual cameras can be used on a smartphone, but still fails to contemplate both left and right side facing cameras.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a smartphone capable of taking at least front and side images concurrently.

### SUMMARY OF THE INVENTION

The inventive subject matter provides apparatus, systems, and methods in which a smartphone is configured to capture images through a front facing aperture, and at least one side facing aperture. Such captures can be made by one or more cameras, which can optionally capture the images concurrently, and can optionally use optical fibers to convey images. The smartphone can also have a back facing camera, which can also capture images concurrently with images received through any of the front facing and side facing apertures. Captured images, whether still and/or moving (video), can being stitched together. Any one or more of the cameras and/or apertures can optionally be digitally and/or physically steerable. Also contemplated is a smartphone case having apertures that correspond to the image receiving apertures of the smartphone.

Various objects, features, aspects, and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1A is a back view of a smartphone, having four cameras, front, back, left, and right facing cameras.

FIG. 1B is a horizontal cross-sectional view of the smartphone of FIG. 1A, depicting preferred viewing angles.

FIG. 2 is a horizontal cross-sectional of a smartphone having three pop-up cameras.

FIG. 3 is a smartphone case, having an aperture corresponding to a camera of a smartphone of FIG. 1A.

FIG. 4 depicts a smartphone in which images received through multiple apertures are carried by optical fibers to a camera.

### DETAILED DESCRIPTION

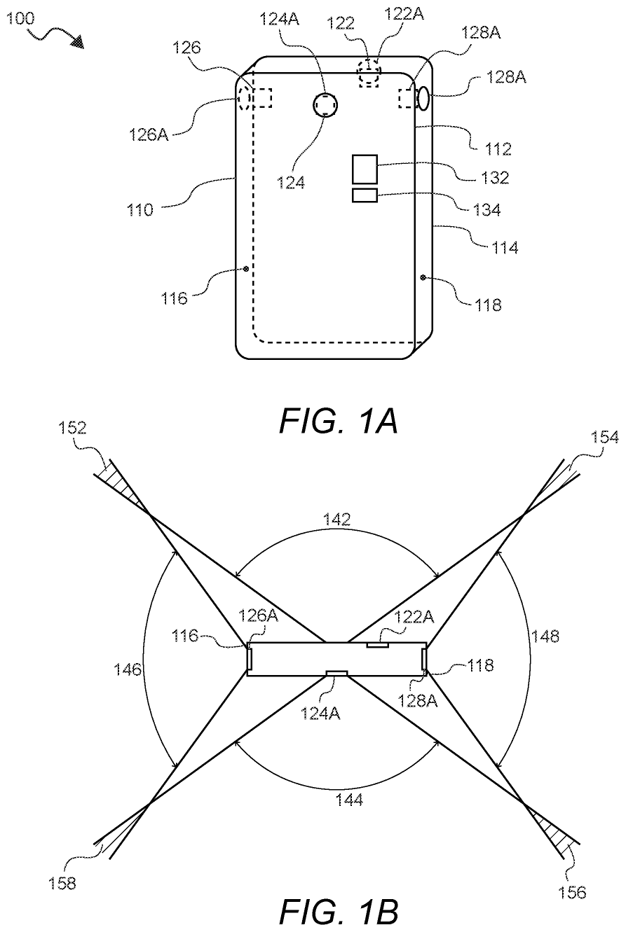

FIG. 1A shows one embodiment of the inventive concept, in which a smartphone 100 generally comprises a body 110 with front 112, back 114, left 116, and right 118 sides, and corresponding front 122, back 124, left 126, and right 128 cameras, as well as a processor 132 and a memory 134 configured to process images from the various cameras. The processor 132 and memory 134 is preferably devoted exclusively to handling of images, but can optionally be utilized for other smartphone functions, including for example cellular communications.

As used herein, the term “smartphone” refers to a device having a microphone, a speaker, at least one camera, and a cellular function capable of transmitting data to/from another device. As used herein, the front side 112 refers to the side facing forward with respect to a user's position. The back side 114 refers to the side facing backwards, towards the user when the smartphone is positioned in front of the user. The left 116 and right 118 sides refer to the sides facing the side view with respect to the user's position. Thus, when the user holds the longer edges of the smartphone 100 vertically, the left and right cameras 116, 118 are oriented approximately horizontally, and when the user holds the longer edges of the smartphone 100 horizontally, the left and right cameras 116, 118 are oriented approximately vertically.

It should be appreciated that the various cameras 122, 124, 126, 128 can be situated on their respective sides 112, 114, 116, 118 in any suitable positions. Each of the cameras 122, 124, 126, 128 has a corresponding aperture 122A, 124A, 126A, 128A. The positions depicted on FIG. 1A are preferred, however, to accommodate holding of the smartphone 100 by a user's hand.

In some embodiments, additional cameras can be included, on any one or more of the front 112, back 114, left 116, and right 118 sides. It is common among newer smartphones stitch together images from multiple cameras to form a single image, known techniques for doing so are contemplated to be used by processor 132 and memory 134. Stitching together of images can be performed in a seamless manner, and/or with seams, as a function of the software and the images. Each of the cameras 122, 124, 126, 128 can be used by itself, or with any one or more of the other cameras, yielding 24 permutations. Processor 132 should be viewed as configured to operate software to digitally steer any one or more of cameras 122, 124, 126, 128.

It should also be appreciated that the camera/aperture locations are described herein assuming the cell phone is in a portrait orientation. When the cell phone is positioned in a landscape orientation, then the left and right cameras/apertures are pointed up and down. Still further, it is contemplated that one or more additional cameras/apertures can be included, such that in a portrait confirmation a cell phone could concurrently record up and/or down images along with front, back, and/or side images.

As used herein, the term “image” generically includes both single images and video (moving images). As is customary with smartphones, images can optionally be associated with sound recordings.

FIG. 1B is a horizontal cross-sectional view of the smartphone of FIG. 1A, depicting preferred viewing angles. Contemplated image viewing angles 142, 144, 146, 148 correspond to cameras 122, 124, 126, 128 (not shown) imaging through apertures 122A, 124A, 126A, 128A, respectively. FIG. 1B depicts overlapping of viewing angles at 152, 154, 156, and 158.

Images from a various cameras 122, 124, 126, 128 can be taken concurrently or even simultaneously. As used herein, images are deemed to be taken concurrently if the gap between recording of the images is less than 1 second, more preferably less than 0.5 seconds, and more preferably less than 0.1 seconds.

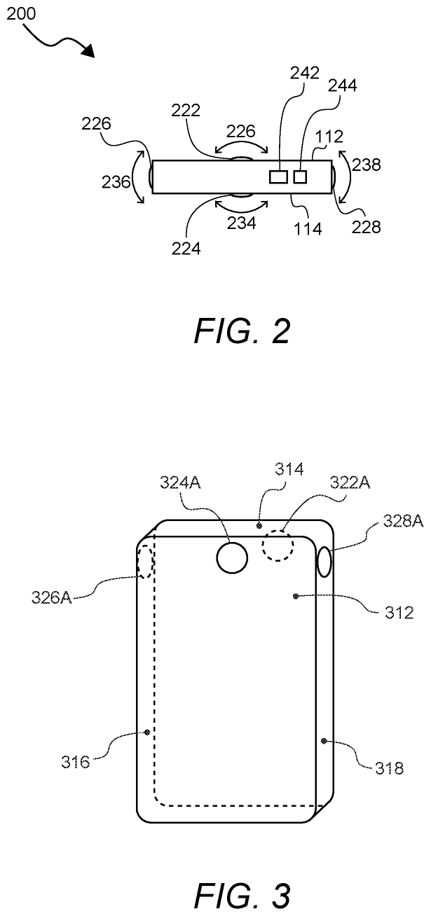

FIG. 2 depicts smartphone 200 with physically steerable imaging apparatus (e.g. cameras, optical fibers or other optical guides) 222, 224, 226, and 228. Front steerable imaging apparatus 222 is steerable horizontally within range 232. Back side steerable imaging apparatus 224 is steerable horizontally within range 234. Left side steerable imaging apparatus 226 is steerable horizontally within range 236. Right side steerable imaging apparatus 228 is steerable horizontally within range 238. Alternative steerable steerable imaging apparatus (not shown) can be gimballed to steer in both horizontal and vertical directions.

Smartphone 200 also includes processor 242 and memory 244, cooperating as discussed above with respect to processor 132 and memory 134, including operation of software to digitally steer any one or more of cameras 222, 224, 226, 228.

FIG. 3 depicts a smartphone case 300 having at least three side of a front 312, back 314, and left 316 and right 318 sides. The smartphone case 300 is sized and dimensioned to accommodate either of smartphones 100 and 200, with apertures 322A, 324A, 326A, 328A suitable to accommodate the corresponding cameras 122, 126, 128 or 222, 226, 228.

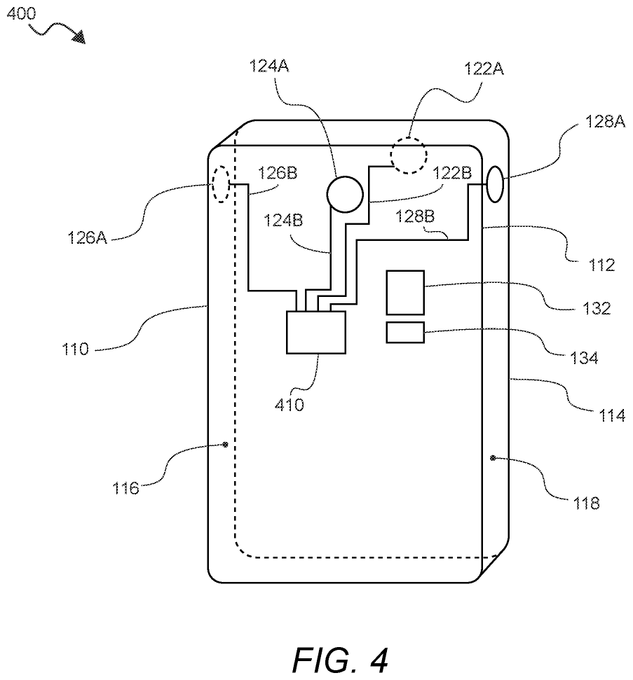

FIG. 4 depicts a smartphone 400 in which images received through apertures 122, 124, 126, 128A are carried by optical fibers 122B, 124B, 126B, 128B to camera 410.

In some embodiments, at least one of the apertures can be covered by a cover. The cover can advantageously comprise a transparent film, plastic, or glass. Contemplated materials include, but are not limited to, polycarbonate, polypropylene, polyethylene, polyester, polyethylene terephthalate, polyamide, polyvinyl chloride, and polystyrene. Contemplated thicknesses of the transparent film, plastic, or glass are in the range of 1 μm-1 mm.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A smartphone comprising:
at least one camera;
a front facing aperture;
a first side-facing aperture, and
wherein the at least one camera is collectively configured to concurrently capture (a) a first image received through the front facing aperture and (b) a second image received through the first side-facing aperture.

2. The smartphone of claim 1, further comprising a processor and a memory configured to combine the first and images into a composite image.

3. The smartphone of claim 1, further comprising a processor and a memory configured to combine the first and images into a composite video.

4. The smartphone of claim 1, further comprising a second side-facing aperture, and wherein the at least one camera is collectively configured to capture a third image received through the second side-facing aperture.

5. The smartphone of claim 4, wherein the first and second side-facing apertures are disposed on left and right sides of a body of the smartphone, respectively.

6. The smartphone of claim 4, further comprising a processor and a memory configured to combine the first, second, and third images into a composite image.

7. The smartphone of claim 4, further comprising a processor and a memory configured to combine the first, second, and third images into a composite video.

8. The smartphone of claim 1, wherein at least one of the first and second apertures is physically steerable.

9. The smartphone of claim 1, further comprising a back-facing camera, and wherein the at least one camera is collectively configured to capture a third image received through the back-facing aperture.

10. The smartphone of claim 1, wherein the at least one camera comprises at least a first camera and a separate second camera, the first camera is configured to capture the first image through the front-facing camera, and the second camera is configured to capture the second image through the first side-facing camera

11. The smartphone of claim 1, further comprising an optical fiber that conveys light coming through at least one of the font-facing and first side apertures into the at least one camera.

12. A smartphone case having a front facing camera aperture, and at least one of a left side-facing camera aperture and a right side-facing camera aperture.
